(19) United States
(12) Patent Application Publication
(10) Pub. No.: US 2012/0124517 A1
(43) Pub. Date: May 17, 2012

(54) IMAGE DISPLAY DEVICE PROVIDING IMPROVED MEDIA SELECTION

(76) Inventors: Lawrence B. Landry, Victor, NY (US); Michael J. Telek, Pittsford, NY (US); Lars D. Perkins, La Canada, CA (US)

(21) Appl. No.: 12/946,055

(22) Filed: Nov. 15, 2010

(51) Int. Cl. G06F 3/048

(52) U.S. Cl. 715/810

(57) ABSTRACT

A digital image display device for displaying a collection of digital media assets, comprising a display screen; a processor; a network connection for receiving digital media assets provided by a plurality of individuals; an image memory for storing the received digital media assets together with associated metadata; and a user interface. A program memory stores instructions for causing the processor to execute the steps of: displaying identifiers on the display screen for a plurality of individuals who have provided digital media assets; receiving input from a user of the digital image display device identifying a particular individual; selecting digital media assets provided by the identified individual responsive to the metadata; and displaying the selected digital media assets on the display screen.

### FIELD OF THE INVENTION

This invention pertains to the field of digital media frames, and more particularly to digital media frames that display images provided over a network from a variety of sources.

### BACKGROUND OF THE INVENTION

A digital media frame (also called a digital photo frame, a digital picture frame or a digital image display device) is a device that electronically stores and displays digital images. As used herein the term digital image includes both digital still images and digital video images. The digital images are typically captured using digital cameras (still or video), but may also be obtained using other types of digital image sources such as scanners. For example, U.S. Pat. No. 4,754,271 to Edwards, entitled “Liquid Crystal Photograph,” describes a device resembling a pocket calculator which stores still pictures in a digital memory cartridge, and displays the pictures on a liquid crystal display (LCD) screen. The device includes an auto-sequencing mode which automatically changes the displayed image after a user-selectable time period, such as 5 seconds, or 5 minutes.

Digital media frames can include a modem to receive digital images over a communications network from computers or other devices, as described in commonly-assigned U.S. Pat. No. 7,155,679 to Bandaru, et al., entitled “Digital Media Frame,” which is incorporated herein by reference. Such a digital media frame is commonly known as a “connected frame”. This patent further teaches that the connected digital media frame can include an information mode which displays news headlines, stock trading news, weather reports, and advertising received over the communications network.

Some digital media frames can receive digital images over a network from a “share group” which includes a plurality of members, as described in commonly-assigned U.S. Pat. No. 6,509,910 to Agarwal, et al., entitled “Method and system for interfacing with a digital media frame network,” which is incorporated herein by reference. This patent teaches that images provided by various sharing members can be downloaded from a network service and automatically displayed on digital media frames which communicate with the network service.

FrameChannel is an Internet service that can be used with a digital media frame having a modem which enables an Internet connection, such as a WiFi modem, that enables communication with an Internet Service Provider (ISP) via a wireless home router. A FrameChannel customer can use a home computer to access the FrameChannel website (www.framechannel.com) in order to customize the content that will be provided to their digital media frame. The customer can select from many different channels of custom content including news, traffic, weather, sports, and financial data. The customer can also use FrameChannel to receive photos from social networking or digital image sharing websites such as Facebook and Flickr, and to receive photos via E-mail and camera phone messages.

Some prior art imaging software applications use image icons to assist in the categorization and retrieval of digital images from a collection of digital images, as described in commonly assigned U.S. Pat. No. 6,810,149 to Squilla et al., entitled “Method and system for cataloging images,” which is incorporated herein by reference. For example, the image icons can include the faces of different people familiar to user, who are portrayed in some of the digital images in the collection. The user manually identifies images which should be “tagged” using the icons. When the user selects a particular icon on their computer screen, the images associated with that icon are retrieved and displayed.

In current connected digital media frames, it is common to see a slide show of pictures without knowing the origin of the images, since the images may have been obtained from many different digital image sharing websites and individuals. Normally, the images are displayed in an order that is determined by when the images were received by the digital media frame, or by when they were first captured by a digital camera, although some frames allow images to be displayed in a random order, or allow the user to manually modify the order in which images are displayed.

As the available memory in digital media frames increases, it is possible to store and view several thousand different digital images. The large number of digital images makes is difficult to find specific digital images of interest. For a connected digital media frame where digital images and other content can be received from multiple sources, this problem is even more difficult, since the owner of the digital media frame often can recall who provided the digital images, but not when the digital images were sent or captured.

When people view digital images on a digital media frame, they often want to see a specific digital image, or a small subset of the digital images stored in the frame, in order to “relive” a specific event, or “tell a story”. Therefore, it may be desirable to temporarily sort the digital images stored in the digital media frame based on specific search criteria. For example, one might want to display only the digital images provided by a specific friend. Alternatively, one may choose to display content from only a certain album shared with the digital media frame by the specific friend.

However, current digital media frames do not enable a user to easily find specific digital images that have been shared by particular individuals. As a result, it is difficult to easily locate specific groups of digital images stored on digital media frames. What is needed is a way to automatically provide a simpler and easier user interface that enables digital images of interest to be easily and quickly located and displayed.

### SUMMARY OF THE INVENTION

The present invention represents a digital image display device for displaying a collection of digital media assets, comprising:

a display screen;

a processor;

a network connection for receiving digital media assets provided by a plurality of individuals using one or more sharing methods;

an image memory for storing the received digital media assets together with metadata associated with the received digital media assets, wherein the metadata includes an association of the received digital media assets with the corresponding individuals who provided the received digital media assets;

a user interface for receiving input from a user of the digital image display device; and

a processor-accessible program memory storing executable instructions for causing the processor to execute the steps of:
displaying identifiers on the display screen for a plurality of individuals who have provided digital media assets;
receiving input from a user of the digital image display device via the user interface identifying a particular one of the plurality of individuals;
selecting one or more of the received digital media assets provided by the identified individual, wherein the received digital media assets are selected responsive to the metadata associating the received digital media assets with the corresponding individuals; and
displaying the selected digital media assets on the display screen.

This invention has the advantage that a user of the digital image display device can easily select and display digital images and videos that have been received from a particular individual from collections of digital media assets.

It has the additional advantage that the digital media assets received from the particular individual can be received using a variety of sharing methods including E-mail sharing methods, social networking website sharing methods, digital image sharing website sharing methods, web browser upload sharing methods and direct network upload sharing methods.

### BRIEF DESCRIPTION OF THE DRAWINGS

FIG. 1 is a high-level diagram depicting the components of a digital image display device;

FIG. 2A and FIG. 2B depict the front and back of a digital image display device;

FIG. 3 is a high-level system diagram depicting how the digital image display device of FIG. 1 communicates with other devices to receive content and configuration information;

FIG. 4A is a high level flow diagram depicting a general image display process;

FIG. 4B is a high level flow diagram depicting a general system communications process;

FIG. 5 is a flow diagram showing a method for providing an improved media selection interface on a digital media frame in accordance with the present invention;

FIG. 6 is a graphical user interface providing improved media selection in accordance with the present invention;

FIG. 7A depicts a collection of digital images stored in the digital media frame;

FIG. 7B depicts digital images from the collection of digital images that are displayed when a first icon is selected; and

FIG. 7C depicts digital images from the collection of digital images that are displayed when a second icon is selected.

It is to be understood that the attached drawings are for purposes of illustrating the concepts of the invention and may not be to scale.

### DETAILED DESCRIPTION OF THE. INVENTION

In the following description, some embodiments of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, a computer program for performing the method of the present invention can be stored in a non-transitory computer readable storage medium, which can include, for example; magnetic storage media such as a magnetic disk (e.g., a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because digital media frames and related circuitry for providing digital interfaces, digital image storage, digital image processing, and image display are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown, described or suggested herein that is useful for implementation of the invention is conventional and within the ordinary skill in such arts.

The following description of digital media frames will be familiar to one skilled in the art. It will be obvious that there are many variations of this embodiment that are possible and are selected to reduce the cost, add features or improve the performance of the digital media frame. The present invention is illustrated by way of example and not limitation in the accompanying figures.

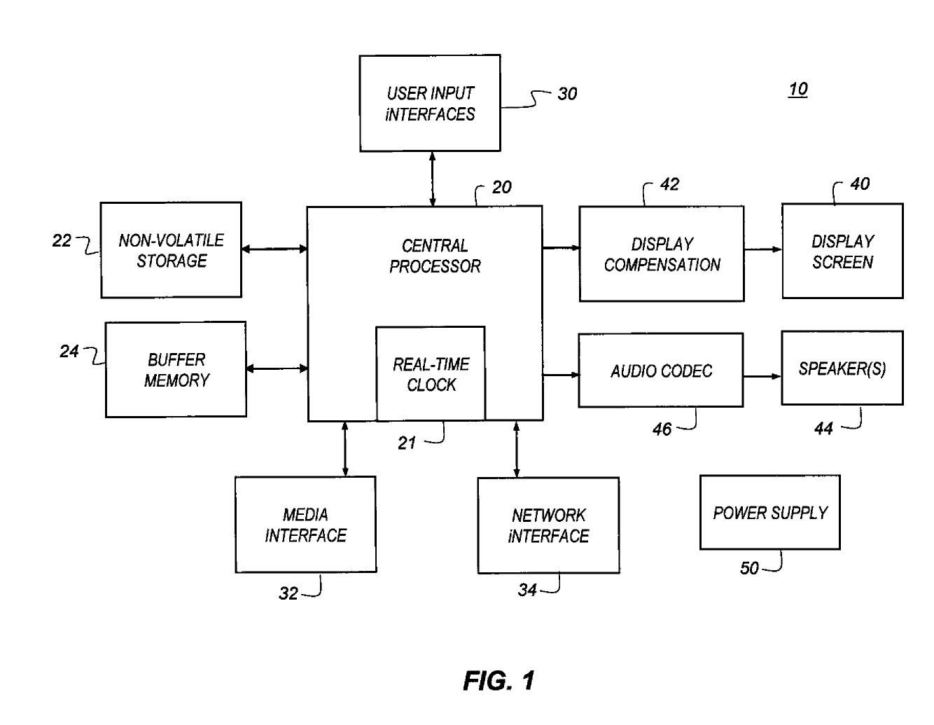

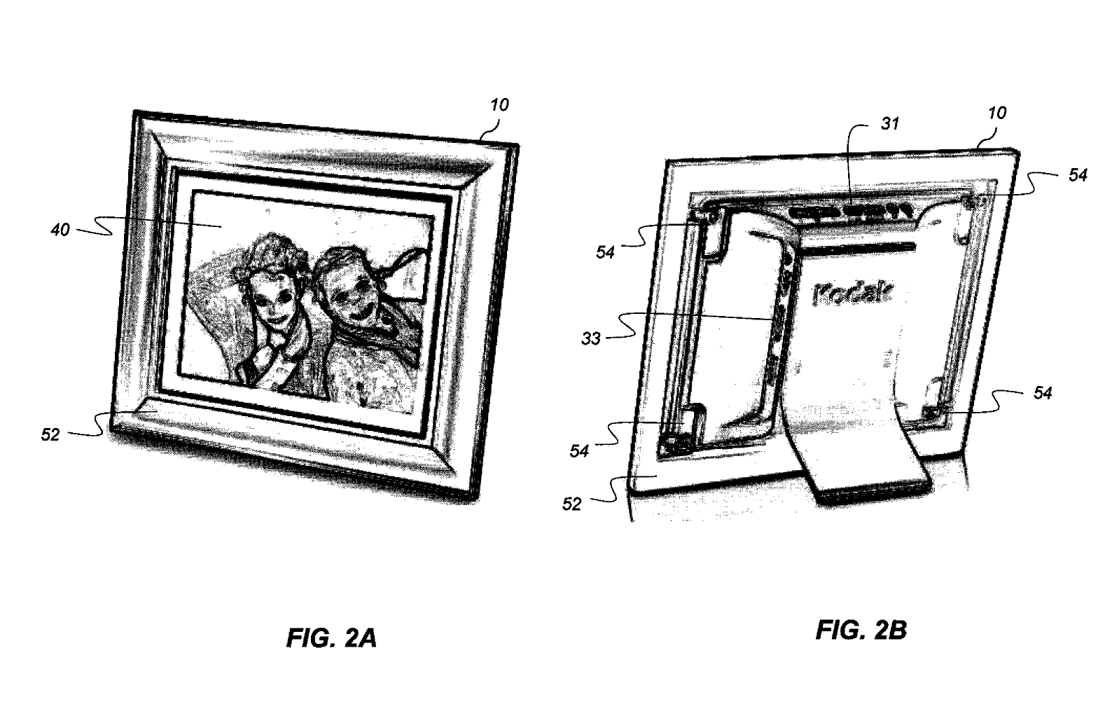

FIG. 1 is a high-level block diagram depicting an embodiment of a digital image display device 10. In a preferred embodiment, the digital image display device 10 is a digital media frame (i.e., a digital picture frame or a digital photo frame). However, in other embodiments, the digital image display device 10 can be any device having the ability to display digital media assets on a soft-copy display. Digital media assets would include both digital still images and digital video images. Examples of other types of digital image display devices 10 that can be used in accordance with the present invention would include tablet computers, personal computers, hand-held electronic devices (e.g., smart phones, PDAs or digital media players) and digital televisions. FIG. 2A depicts an embodiment of a front view of the digital image display device 10, and FIG. 2B depicts an embodiment of a rear view of the digital image display device 10. The digital image display device 10 includes a frame surround 52 which can be removed by moving the sliders 54 and replacing the frame surround 52 with a different frame surround, which may have a different color, finish, etc.

The digital image display device 10 allows a user to display digital media assets with minimal user intervention. The digital media assets to be displayed typically includes digital still images captured with a digital camera. The digital media assets to be displayed can also include video clips, graphic images, text, and animations. The digital media assets can also include audio information, such as music, speech, and sound effects.

Referring to FIG. 1, a central processor 20 in the digital image display device 10 provides the overall control of the digital image display device 10. The central processor 20 is coupled to a user input interfaces block 30, which enables a user of the digital image display device 10 to select operating modes and images to be displayed. The central processor 20 is also coupled to a media interface block 32, and a network interface block 34, which are used to provide digital media assets to the digital image display device 10. The central processor 20 is also coupled to a non-volatile storage block 22 via an interface, which provides a processor-accessible program memory that stores executable instructions that are used to control the operation of the central processor 20. Non-volatile storage block 22 can also serve as a processor-accessible image memory for storing a collection of digital media assets.

The central processor 20 is also coupled to a buffer memory block 24, which temporarily stores digital media assets for display on display screen 40. The central processor 20 is also coupled to a display compensation block 42, which processes the digital images and provides the compensated digital images to the display screen 40. The central processor 20 is also coupled to an audio codec block 46, which processes digital audio information and converts the digital audio information to one or more analog signals, which are provided to one or more speakers 44.

The user input interfaces block 30 can be provided using various conventional user input devices and circuits. For example, the user input interfaces block 30 can include a group of user buttons 31, such as those provided on the upper back of the digital image display device 10 in FIG. 2B. These user buttons 31 can include, for example, a forward function button, a reverse function button, and a pause function button. The forward function button allows the user to initiate the display of the next image in a playlist, the reverse function button allows the user to initiate the display of the previous image in a playlist, and the pause function button allows the user to initiate the continued display of the current image, until a different function button is pressed by the user. The user buttons 31 can also include a “menu” button, a “select” button” and a number of cursor movement buttons, such as “up,” “down,” “left” and “right,” or some subset thereof. These can be used to select various operating modes.

In some embodiments, the user input interfaces block 30 includes a touch screen interface provided on the front surface of the display screen 40. In some embodiments, the touch screen interface can be implemented using IR emitters and detectors in front of, and parallel to, the display screen 40. A “touch” is detected by determining which IR beams have been blocked by the viewer's finger. In some embodiments, this can be implemented using a relatively small number of emitters and detectors. For example, using 5 emitters spaced vertically and 8 detectors spaced horizontally, enables the detection of 5×8 positions on the display screen. This is enough to allow touch buttons icons to be displayed on the display screen 40 and discern which button icon was touched by the viewer.

In some embodiments, the user input interfaces block 30 includes a touch sensitive input surface that can be positioned adjacent to the display screen 40. For example, the KODAK EASYSHARE P730 Digital Frame includes two “Quick Touch Border” capacitive touch strips, including a horizontally oriented touch strip adjacent the bottom of the display screen 40 and a vertically oriented touch strip adjacent the right side of the display screen 40. Menu items are displayed on the display screen 40 adjacent to these touch strips, and the viewer touches the strip at the appropriate location in order to select menu items. One advantage of the Quick Touch Border is that it keeps fingerprints off of the display screen 40.

In some embodiments, the user input interface can also include a pointing device such as a computer mouse, a joy stick, a track ball, or a track pad. In some embodiments, the user input interface can also include a remote control input device. The remote control can include user inputs which replicate some or all of the functions provided by the user buttons 31. In some embodiments, the user input interface can also include a voice recognition interface (including a microphone and speech recognition processor) or a gesture recognition interface that includes a sensing device (such as a camera) which recognizes user hand gestures or other user movements.

Non-volatile storage block 22 represents non-volatile storage memory, which may include, for example, flash EPROM memory. Non-volatile storage block 22 provides a processor-accessible program memory for storing executable instructions, such as firmware programs, for controlling the operation of the central processor 20.

In some embodiments, the firmware programs stored in non-volatile memory block 22 can be updated or replaced by new firmware provided using the media interface block 32 or the network interface block 34. In some embodiments, other types of non-volatile memory, such as Read Only Memory (ROM), magnetic disk storage or optical disc storage, can be used. In some embodiments, the central processor 20 includes an additional program memory (not shown), and the firmware programs stored in the non-volatile storage block 22 are copied into the program memory before being executed by the central processor 20.

The non-volatile storage block 22 can also be used to provide a processor-accessible image memory for storing a collection of digital media assets such as still images, video clips, sounds music, graphics, text, and other types of content which can be used to create the images displayed on the display screen 40 and the sounds output from speaker(s) 44. These sounds can include sounds captured by the digital still or video camera when the digital images were captured. These sounds can also include sounds (such as audio annotations) captured when the images were previously viewed, either by the user or another individual. These sounds can also include songs or music soundtracks that have been associated with the digital images. In some embodiments, at least some of the stored digital media assets are associated with particular events either automatically as a result of the image capture date, or as a result of manual selection by the user. The sounds can also include audio content associated with the particular events.

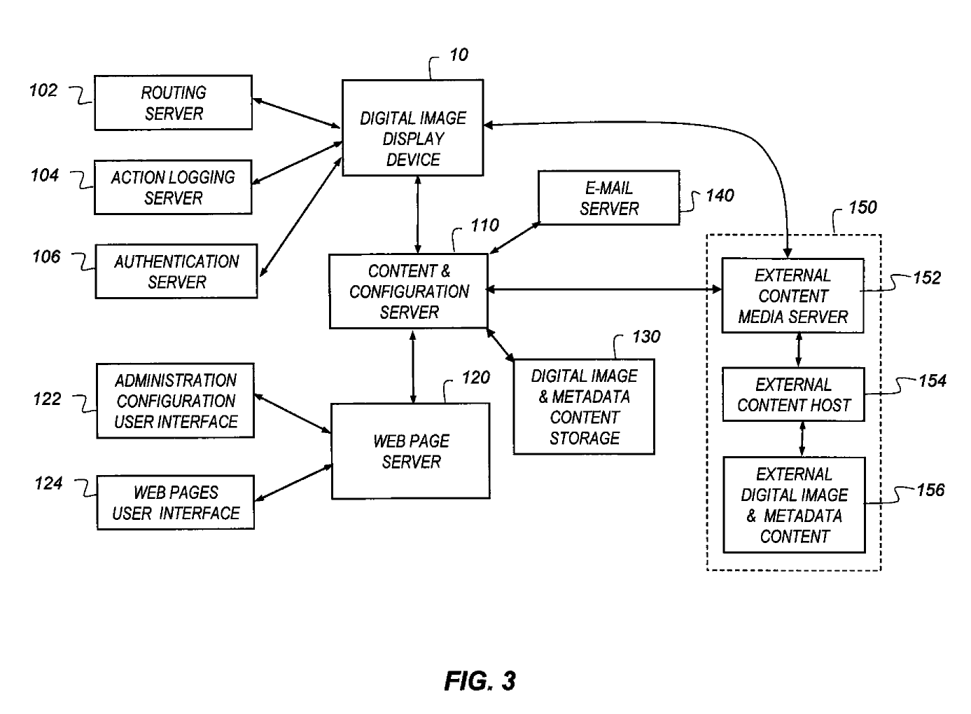

The non-volatile storage block 22 also stores auxiliary information (e.g. metadata) associated with the digital media assets. This metadata can include the date and time the image was captured by a digital capture device (e.g., a digital still camera or a digital video camera), or the date and time the image was received by the digital image display device 10. The metadata can also include data which identifies the individual or service that provided the digital media assets that was transferred to the digital image display device 10 using the system to be described later in reference to FIG. 3.

Buffer memory block 24 is a relatively small memory (compared to non-volatile storage block 22) which provides fast memory access for displaying images. The buffer memory block 24 can use, for example, one or more dynamic random access memory (“DRAM”) or static random access memory (“SRAM”) integrated circuits.

The media interface block 32 receives digital media files from various local external devices, such as removable media devices. For example, the media interface block 32 can include memory card and USB interface connectors 33 (FIG. 2B), to enable the digital image display device 10 to display media files stored on various removable Flash memory cards, such as a Secure Digital (SD) card, a micro SD card, a Compact Flash (CF) card, a MultiMedia Card (MMC), an xD card or a Memory Stick, as well as USB memory “sticks” or “jump drives”. The digital media assets stored on these memory devices can be provided by digital computers, digital still cameras, digital video cameras, camera phones, PDAs, print and film scanners, and other types of digital imaging devices. The central processor 20 controls the media interface block 32 in order to transfer media files from the local external devices. The transferred files can be stored in the non-volatile storage block 22, or can be stored directly in the buffer memory block 24 for immediate display on the display screen 40. Thus, the media interface block 32, in combination with the removable memory card or memory “stick”, provides a processor-accessible image memory for storing a collection of digital media assets, such as digital images.

The network interface block 34 can be used to enable other devices, such as computers or mobile imaging devices, to transfer digital media files to the digital image display device 10. The network interface block 34 can be provided using a wired interface, such as an Ethernet cable interface or a wired telephone modem. The network interface block 34 can also be provided using a wireless interface, such as a WiFi (e.g. IEEE 802.11 WiFi standard) modem, a cellular modem, or a Bluetooth modem.

In some embodiments, the network interface block 34 provides a direct connection to the Internet, and is configured to read HTML (“HyperText Markup Language”) and to use TCP/IP (“Transmission Control Protocol/Internet Protocol”). In other embodiments, the network interface block 34 provides a connection to a local area network, which can then provide an Internet connection using a wired or wireless router or other type of network interface device, which either interfaces directly to the Internet, or to an Internet Service Provider (ISP).

The display compensation block 42 is used to adjust the image data for the characteristics of the display screen 40. This can include tone scale adjustments, color adjustments, sharpness adjustments or any other type of appropriate adjustment. It should be noted that in some embodiments, the display compensation block 42 can be implemented by the central processor 20. In other embodiments, the display compensation block 42 and central processor 20 can be integrated into the same integrated circuit (“IC”).

The display screen 40 displays images using a soft-copy display device, such as a color active matrix LCD (“Liquid Crystal Display”). Other types of soft-copy display devices may be used, such as an OLED (“Organic Light Emitting Diode”) display, a CRT (“Cathode Ray Tube”), or various silicon-based displays.

A power supply 50 converts the AC power supplied via a wall plug to the proper DC voltages needed to provide power to all of the components of the digital image display device 10. In some embodiments, the power supply can include a re-chargeable battery, so that the digital image display device 10 can be portable, thus allowing it to be used for a period of time without a power cable, and outdoors. In some embodiments, the digital image display device 10 can include a solar panel which is used to charge the rechargeable battery.

In some embodiments, the digital image display device 10 includes a motion sensor (not shown). The motion sensor can provide a signal to the central processor 20, which controls the power supply 50 in order to supply power to the display screen 40 only when motion is detected. This reduces the power wasted when displaying images if there are no viewers in the vicinity of the digital image display device 10.

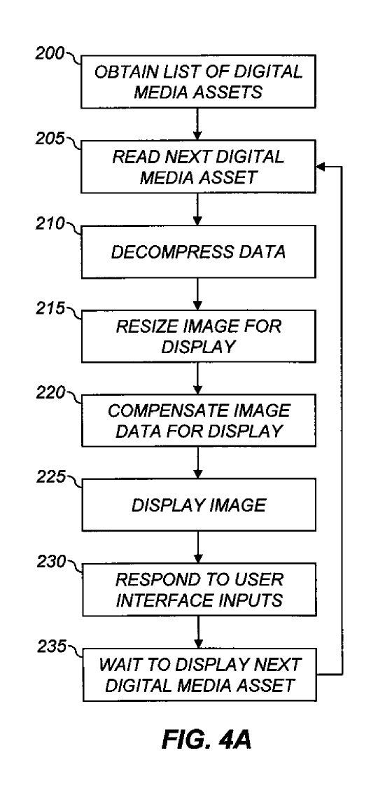

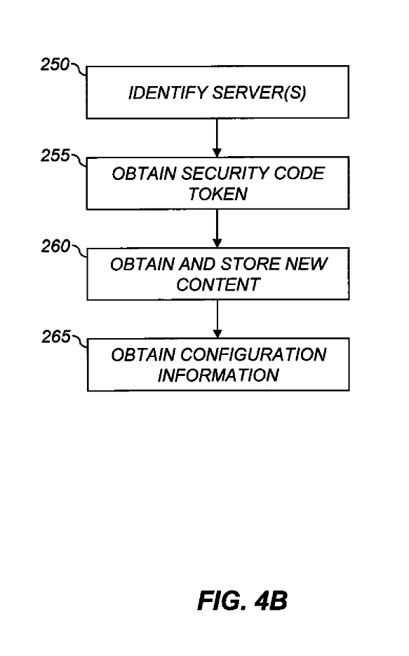

The central processor 20 runs two primary processes in order to display images and communicate with other system components, as will be described later in reference to FIG. 4A and FIG. 4B. A real-time clock 21 in the central processor 20 provides a date/time value. In some embodiments, the real-time clock 21 is manually configured by the user while in other embodiments, the real-time clock is configured using information accessed on an external device such as a Network Time Protocol (NTP) server using the network interface block 34.

It will be understood that the functions of the central processor 20 can be provided using a single programmable processor or by using multiple programmable processors, including one or more digital signal processor (DSP) devices. Alternatively, the central processor 20 can be provided by custom circuitry (e.g., by one or more custom integrated circuits (ICs) designed specifically for use in digital media frames), or by a combination of programmable processor(s) and custom circuits. It will be understood that connections between the central processor 20 and some of the blocks shown in FIG. 1 can be made using a common data bus. For example, in some embodiments the connection between the central processor 20, the non-volatile storage block 22, the buffer memory block 24, the media interface block 32, and the network interface block 34 can be made using a common data bus.

FIG. 3 is a high-level system diagram depicting an embodiment of how the digital image display device 10 can communicate over a network with other systems to receive content and configuration information. It will be understood that a large number of digital image display device 10 units, located at many different geographically dispersed locations, can be supported by the system depicted in FIG. 3. The digital image display device 10 communicates over a network (such as the Internet) with a routing server 102, an action logging server 104, and an authentication server 106. The digital image display device 10 also communicates over the network with content and configuration server 110. The content and configuration server 110 communicates with a web page server 120. The web page server 120 can be controlled by an administration configuration user interface 122 and a web pages user interface 124. The content and configuration server 110 can obtain digital image and metadata content and store it in digital image and metadata content storage 130. The digital image and metadata content can originate into this system from an E-mail server 140, from the web page server 120 or from one or more content providing systems 150. The content providing systems 150 can provide content from a variety of sources, such as Facebook, Flicker, the Kodak Gallery, and other on-line content storage systems and services.

Each content providing system 150 can include an external content media server 152 which communicates with an external content host 154 in order to supply external digital image and metadata content 156. The external digital image and metadata content 156 can be stored on hard drives or other digital storage devices or media that can be accessed by the external content host 154.

In some embodiments, the content and configuration server 110 only provides a list of digital media assets together with appropriate information about each digital media asset. The digital image display device 10 can subsequently access digital media files directly from the content providing systems 150.

It will be understood that the various blocks shown in FIG. 3 can be implemented using different hardware configurations. For example, the routing server 102, action logging server 104 and authentication server 106 can execute on the same physical hardware, or on different hardware. Furthermore, each server, such as routing server 102, may execute on multiple pieces of hardware in order to execute operations in parallel.

FIG. 4A is a high level flow diagram depicting a general image display process performed by the central processor 20 as a foreground process. In obtain list of digital media assets step 200, the central processor 20 gets a list of digital media assets to be displayed from the non-volatile storage block 22 or from some other digital media asset storage location (e.g., storage media connected via the media interface block 32, or a remote storage location accessible via the network interface block 34). A digital media asset is a discrete piece of digital media content such as a digital still image, a digital video clip, a digital audio clip or music file, as well as graphics, text, and other types of content that can be used to create the images displayed on the display screen 40 and the sounds output from speaker(s) 44 of the digital image display device 10. A collection of digital media assets is the set of all the digital media assets that are available for display or playback on the digital image display device 10. A list of digital media assets is a list of the individual digital media assets in the collection of digital media assets. This list can be stored as a formatted text file (e.g. an XML file), as a database or in some other custom storage format. The list can be provided in the display order in which content is to be displayed, or the display order can be specified as a separate field or as a subsequent list referring back to the assets in the list. In some operating modes of the digital image display device 10, the content is intentionally displayed in a randomized order.

In read next digital media asset step 205, the central processor 20 reads the list and determines the next digital media asset to display from the list. The central processor 20 then reads the digital media asset from the non-volatile storage block 22 or the storage media connected to media interface block 32. In some embodiments, the central processor 20 can read the digital media asset from a remote storage site via the network interface block 34.

In decompress data step 210, the central processor 20 decompresses the image data associated with the digital media asset and stores the decompressed image data in the buffer memory block 24. If the digital media asset is a video file, such as an MPEG 2 or MPEG 4 video file, the central processor 20 performs real-time decompression of the compressed video file.

In resize image for display step 215, the central processor 20 scales the image for display, by resizing the image as necessary in order to match the image size (i.e., the display screen resolution) required by display screen 40. In some embodiments, the image size stored in buffer memory block 24 is slightly larger than the screen resolution, in order to allow for some panning/zooming effects as the image is displayed.

In compensate image data for display step 220, the display compensation block 42 applies compensation to the image data before it is provided to the display screen 40. The compensation typically includes adjusting the image to account for the characteristics of the display screen 40 (e.g., an LCD panel). In some embodiments, the compensation may also adapt to the content of the specific image, for example, to provide image-specific enhancements.

In display image step 225, the central processor 20 displays the current image on the display screen 40. The central processor 20 can also display visual messages or user interface controls on the display screen 40, to indicate to the user of the digital image display device 10 various operating modes and options that can be selected by the user. In some embodiments, the central processor 20 provides these messages and controls using an on-screen graphics buffer, which can be stored in a portion of buffer memory block 24. The graphics information provided from this on-screen graphics buffer can be blended with the currently displayed image when the user activates one of the user interface elements of the user input interfaces block 30, such as a touch screen interface. In some embodiments, the text and icons are transparently overlaid on top of the currently displayed image.

In respond to user interface inputs step 230, if the user makes a selection using one of the user input elements, the central processor 20 takes one or more actions in response to the user selection. This can include, for example, changing the display time for images, deleting an image from the collection of digital media assets, or selecting a subset of the collection of digital media assets to display.

In wait to display next digital media asset step 235, the central processor waits until the real-time clock 21 has advanced by a specified time interval between images, and then execution returns to the read next digital media asset step 205. The specified time interval can be a factory default time interval (e.g., 10 seconds per image) or can be a time interval selected by the user using appropriate user interface elements. The central processor 20 also controls the type of transition between images. The transition is a mechanism of “retiring” the current image while “phasing in” the next image. For example, one type of image transition moves the current and next images in one direction (e.g. left to right, or top to bottom) such that the current image moves out while the next image moves in. In another example, the image transition fades out the current image while fading in the next image on top of the current image. Those skilled in the art will recognize that many different types of transitions can also be used.

FIG. 4B is a high level flow diagram depicting a general system communications process for secure information exchange over an insecure network, which is performed by the central processor 20 via the network interface block 34 as a background process. In some embodiments, the network interface block 34 is a WiFi wireless interface, which enables the digital image display device 10 to wirelessly communicate with various servers such as routing server 102, action logging server 104, authentication server 106 and content and configuration server 110 over a network, such as the Internet.

At startup, an identify server(s) step 250 is performed, during which the digital image display device 10 interfaces via network interface block 34 over the Internet to the routing server 102 at a known server location, in order to identify itself and determine how to proceed. The routing server 102 returns information to the digital image display device 10 that indicates which server(s) the digital image display device 10 should communicate with for all subsequent functions. The only address that is not allowed to change is the path to this routing server 102.

In obtain security code token step 255, the digital image display device 10 uses a secure communication method (e.g. https://) to query the authentication server 106 for a security code to communicate with the rest of the system. This query involves transmission of private information that is known by both the digital image display device 10 and the authentication server 106. The authentication server 106 generates a temporary security token and returns the token to the digital image display device 10. The token is made available to other parts of the server (and other servers) to allow authentication of the particular digital image display device 10 for future operations.

When the time window for the authentication token expires, any operations from the digital image display device 10 to one of the servers (other than the authentication server 106) will be rejected. In this situation, the digital image display device 10 then communicates with the authentication server 106 in order to acquire a new authentication token, before continuing with other operations. The use of a temporary token for most of the communications between the digital image display device 10 and each of the servers has the advantage of minimizing exposure to the private information shared between the digital image display device 10 and the authentication server 106 and the advantage of minimizing the computation required for subsequent communications by reducing the need for secure communications with a temporary token.

In obtain and store new content step 260, the digital image display device 10 communicates with the content and configuration server 110 in order to retrieve any new content that may be available. The digital image and metadata content provided by the content and configuration server 110 is organized into groups of pictures that are grouped by some combination of the source of the content (e.g., E-mail, Facebook or Kodak Gallery), a unique identifier of the sender of that content (e.g., the E-mail address of the sender who provided the content), and the date and time that the particular content was shared (or the instance of sharing). In some embodiments, a direct network upload sharing method can be used to provide content directly to the digital image display device 10. The direct upload can sharing method can make use of various interfaces such as the well-known FTP or REST interfaces.

The digital image and metadata content provided by the content and configuration server 110 may also be organized by other information related to each particular content such as the location where the particular content was captured, keywords associated with the particular content, names or identity of people captured in the particular content, or things captured in the particular content.

The digital image and metadata content is obtained through a separate interface to content and configuration server 110, and is stored using an appropriate non-volatile storage (not shown) available to the content and configuration server 110. The content and configuration server 110 sends a description of the new content to be stored on the digital image display device 10. The central processor 20 in the digital image display device 10 then individually retrieves each of the digital media assets defined by the content and configuration server 110 and stores each digital media asset in the non-volatile storage block 22 in the digital image display device 10. The digital image display device 10 also transfers metadata related to each digital media asset, such as the sharing method (e.g., E-mail, Facebook or Kodak Gallery), an identifier for the individual providing the digital media asset, an identifier of the sharing instance, and any descriptive text available related to the digital media asset. In some embodiments, the digital media assets are only downloaded from the content and configuration server 110 at the time when they are to be displayed on the digital image display device 10, and are not stored locally in the non-volatile storage block 22 in the digital image display device 10. In some embodiments, the digital media assets are stored in non-volatile storage block 22 using a cache mechanism and the digital media assets are retrieved from the non-volatile storage block 22 if the digital media asset is stored in the non-volatile storage block 22 and has not been updated on the content and configuration server 110, and further, if the digital media asset is not stored in the non-volatile storage block 22 the central processor 20 retrieves the digital media asset from the content and configuration server 110 and stores the asset into the cache mechanism stored on the non-volatile storage block 22. The details of the data cache mechanism will be familiar to one knowledgeable in the arts.

The user can add content to the digital image display device 10 by using a web browser upload sharing method via the web pages user interface block 124 to upload digital images and other digital media assets to the web page server 120. The web page server 120 then stores these digital media assets and appropriate metadata.

In obtain configuration information step 265, the digital image display device 10 communicates with the content and configuration server 110 in order to retrieve configuration information. The configuration information includes settings such as the type of slideshow transition, the time interval for displaying each slideshow image, and the time of day to automatically turn the digital image display device 10 on and off.

In some embodiments, factory default configuration information is stored on the content and configuration server 110 automatically when a digital image display device 10 is registered. The user can utilize the web pages user interface block 124 to modify the configuration information. Additionally, configuration information can be modified by a system administrator using the administration configuration user interface 122, in order to address any service related issues or to provide updates.

The user can use the web pages user interface block 124 to permit E-mail transfer of digital media assets to their particular digital image display device 10. In this case, the user enters a specific E-mail address to enable content to be sent to their digital image display device 10. When E-mail is sent (typically by others) to that address on the E-mail server 140, the digital images and other relevant content is extracted from the E-mail and transferred to the digital image and metadata content storage 130. Metadata about the sender, sharing date, etc. is also stored in association with this content.

The user can also use the web pages user interface block 124 to configure their digital image display device 10 to receive digital media assets that are provided from one or more content providing systems 150 through various external services on the Internet. There are two primary mechanisms for how content is transferred from the external content providing systems 150, depending on how the external system operates.

In a first “pull” mechanism, the content and configuration server 110 periodically polls the external content media server 152 to determine whether new external digital image and metadata content 156 is available from external content host 154. If new content is available, the content and configuration server 110 retrieves the metadata for the new content and stores it in the digital image and metadata content storage 130. The original digital media asset data (e.g., still digital image or digital video file) is not transferred. When the digital image display device 10 later retrieves the list of digital media assets to retrieve, the URL for this new digital media asset will point back to the corresponding external content media server 152.

In a second “push” mechanism, the external content media server 152 provides a notification when new external digital image and metadata content 156 is available from external content host 154. In this case, the content and configuration server 110 configures the external content media server 152 to provide a notification whenever relevant additions or changes are made for the content requested. The external content media server 152 then notifies the content and configuration server 110 when content is added, modified or removed. The content and configuration server 110 then updates the digital image and metadata content stored on the digital image and metadata content storage 130 to reflect the new state of the external content providing systems 150. It will be understood that the content and configuration server 110 stores configuration information for a large number of digital image display device 10 units, and that each digital image display device 10 can be configured to permit content to be provided from a number of different external content providing systems 150 (such as Facebook, Flick, Kodak Gallery, etc.) using “pull” or “push” mechanisms. The obtain and store new content step 260 and the obtain configuration information step 265 are repeated at regular intervals (e.g., every ten minutes) in order to obtain new content for digital image display device 10. In another embodiment, the obtain configuration information step 265 can be initiated by a message being “pushed” from the content and configuration server 110 to the digital image display device 10 that indicated new or updated content may be available on the content and configuration server 110.

In some embodiments, the digital image display device 10 has an “informational” mode as well as a “pictorial digital media asset” mode. The informational mode of digital image display device 10 displays various information, such as news headlines, financial data, advertising, and the like. The information can be displayed instead of, or along with, the pictorial digital media assets. In the latter case, the digital image display device 10 dedicates a portion of the display screen 40 to pictorial display while another portion of the screen is apportioned to informational display. The informational display can be located adjacent to the pictorial display, or can be overlaid on top of the pictorial display. The information to be displayed can be provided using the system depicted in FIG. 3. The types of information to be provided can be configured for a particular user of digital image display device 10 by using the web pages user interface block 124 to select the particular information of interest to the user. This can include information about particular stocks, sport teams, weather reports, news categories, shopping, gambling, etc., which are of interest to the user. In some embodiments, the information can be provided by various information content web servers (not shown) which provide content to the content and configuration server 110. In other embodiments, the digital image display device 10 can communicate directly with the external web sites (not shown) that provide the information, in order to receive and display web pages, using a web browser implemented in the digital image display device 10.

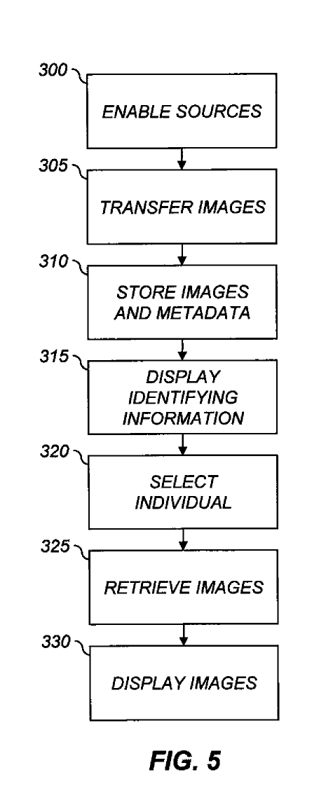

FIG. 5 is a flow diagram showing a method for providing an improved media selection interface on the digital image display device 10. In enable sources step 300, the user enables the digital image display device 10 to receive digital media assets, such as digital still images, from a variety of sources. In some embodiments, this can be done using the web pages user interface block 124 described earlier in reference to FIG. 3. For example, the user can use the web pages user interface block 124 to provide an E-mail address for their digital image display device 10. This E-mail address can then be sent to friends and family members. The friends and family members can send E-mails to this E-Mail address, and the E-mails will be received by E-mail server 140. The E-mails can include digital media assets, such as digital still images. E-mails sent by different individuals to the E-Mail address for the digital image display device 10 are designated as being provided by different sources. In some embodiments, the particular source can be identified by the E-mail address (e.g., a “sent by” or a “reply to” address) that was used to send the E-mail. The content and configuration server 110 can then use the “sent by” or “reply to” address in order to automatically identify the individual who provided the asset. The identity of the individual is stored as metadata along with the asset in digital image and metadata content storage 130. It will be understood that each E-mail can provide a single image, or a plurality of images. The content and configuration server 110 can also store metadata which identifies the E-mail message that provided the assets, so that a plurality of images provided by the same E-mail message can be associated together as a single “sharing instance.”

The user can also use the web pages user interface block 124 to enable their digital image display device 10 to receive digital media assets that are provided from one or more content providing systems 150, using various external services on the Internet. For example, the user can select the Kodak Gallery website, or a website associated with other on-line content storage systems and services. In addition to selecting the content providing system, the user can use web pages user interface block 124 to select the account name(s) used to store the assets that are to be provided to the digital image display device 10. In some embodiments, the user can use the web pages user interface block 124 to select digital media assets matching additional search criteria in order to select only a subset of the digital media assets associated with a particular account name. Examples of search criteria that can be used in accordance with the present invention would include search criteria to identify digital media assets included in a specified album, digital media assets associated with a specified keyword, digital media assets that include one or more specified persons or objects, digital media assets that were captured at a specified capture location, digital media assets that were captured within a specified date range, digital media assets that were received within a specified date range, or digital media assets were received with a specified sharing method

The content providing systems 150 selected by user can include, for example, social networking websites such as Facebook and MySpace, or digital image sharing websites such as Kodak Gallery or Snapfish. In some embodiments, the user can use web pages user interface block 124 to select particular “friends”. The assets that these “friends” upload to their account on the social network website can then be automatically provided to the digital image display device 10 under the control of content and configuration server 110. It will be understood that each “friend” on the social network website serves as a different source of digital media assets.

In transfer images step 305, the content and configuration server 110 transfers the digital media assets to the digital image display device 10. This can be done as described earlier in reference to obtain and store new content step 260 of FIG. 4B. In some embodiments, the digital image display device 10 can be in continuous communication with the content and configuration server 110. In other embodiments, the digital image display device 10 can instead connect and communicate with the content and configuration server 110 on an occasional basis, for example every ten minutes, or every hour, or when digital media assets are pushed down from the content and configuration server 110.

In store images and metadata step 310, the digital image display device 10 receives digital media assets (e.g., digital still images and digital video images) and metadata from the content and configuration server 110 via the network interface block 34, and stores the digital media assets and metadata in the non-volatile storage block 22, or using a storage media attached to media interface block 32. The metadata can be stored using a variety of formats. For example, the metadata can be included in the image files, or can be stored separately from the image files (such as in a database file), or can be stored both in the image files and in a separate database. The metadata enables the stored digital media assets to be grouped according to the individual “source” that supplied the asset. The metadata also enables the stored digital media assets be grouped according to their origin (upload, E-mail, Facebook, Kodak Gallery, etc.). The metadata also enables the stored assets to be grouped according to an “album” or a “sharing instance”.

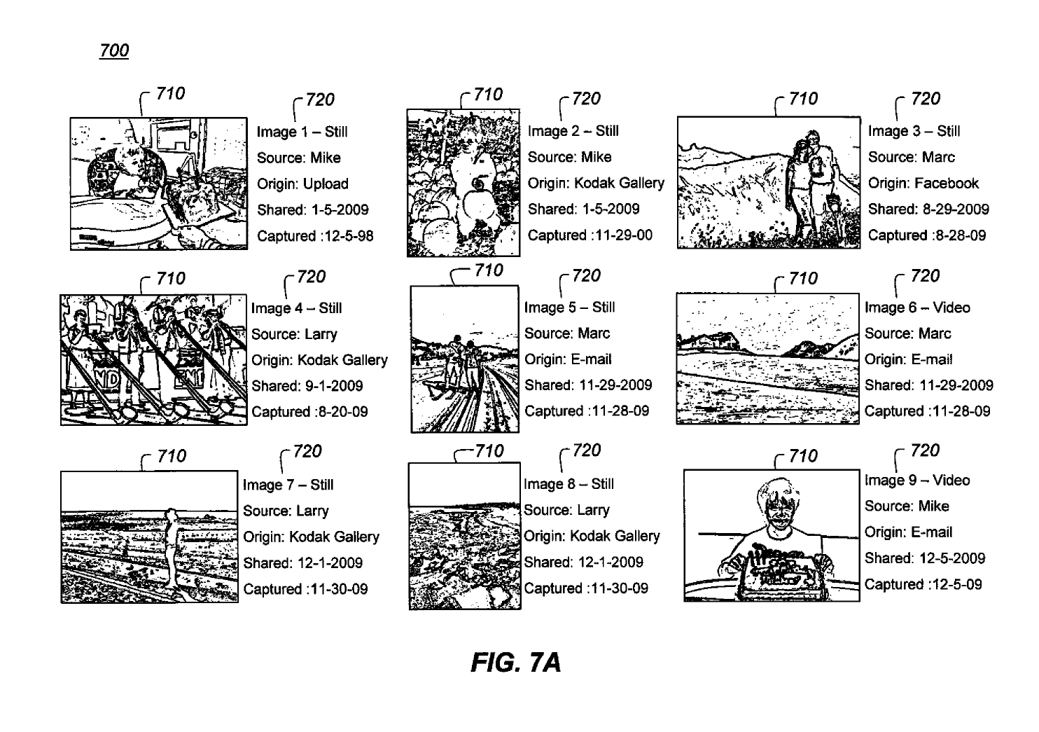

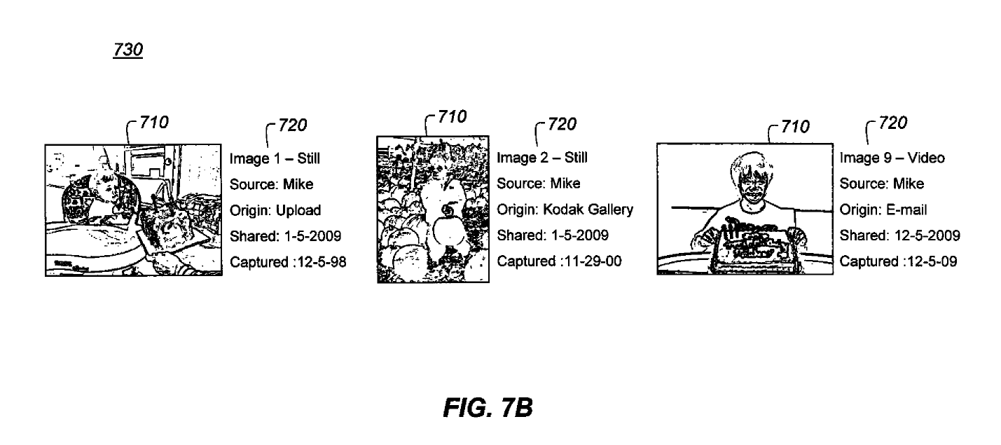

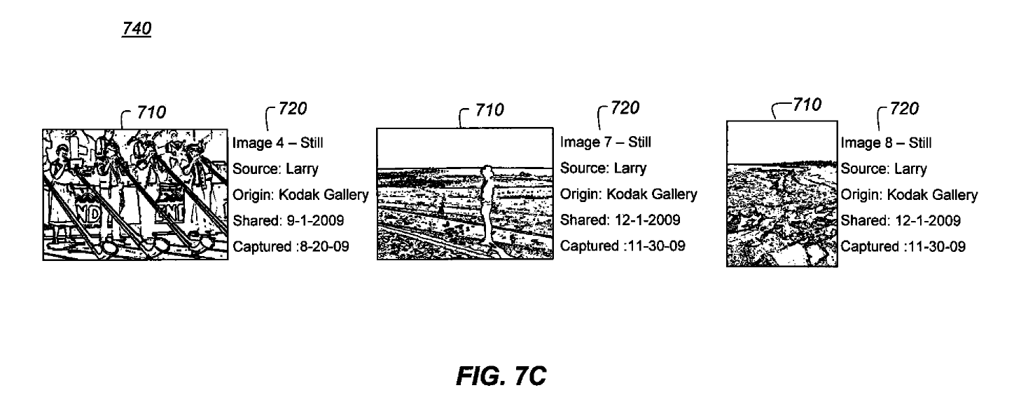

FIG. 7A depicts a collection of digital media assets 700 stored in the digital image display device 10, including nine particular digital media assets 710, and some of the associated metadata 720. The digital media assets 710 include two digital video clips (Images 6 and 9) and seven digital still images (Images 1-5 and 7-8). It will be understood that the digital image display device 10 typically stores a much larger number of digital media assets 710, for example several hundred or several thousand digital media assets 710.

Each of the digital media assets 710 depicted in FIG. 7A has associated metadata 720. The metadata 720 includes a digital media asset identifier (e.g., “Image 1”), and a digital media asset type (e.g., “still” or “video”). The metadata 720 also includes a digital media asset source (e.g., “Mike” or “Larry”) providing an indication of the person who provided the asset, and a digital media asset sharing method providing an indication of the sharing method by which the digital media asset was provided. For example, sharing methods can include an E-mail sharing method (i.e., “E-mail”), social networking website sharing methods (e.g., “Facebook”), digital image sharing website sharing methods (e.g., “Kodak Gallery”), web browser upload sharing methods or direct network upload sharing methods. The metadata 720 also includes a sharing date (“Shared”), which provides the date on which the digital media asset was transferred to the digital image display device 10, as well as a capture date (“Captured”), which is the date that the digital media asset 710 was captured by a digital camera, or scanned by a digital image scanner. The capture date metadata can be provided, for example, by the date/time metadata included in the well-known Exif-JPEG image format when the digital media asset 710 was captured by a digital camera.

It will be understood that many other types of metadata 720 can be stored in association with the digital media assets 710 stored in the digital image display device 10. This metadata 720 can include, for example, the names of people pictured in the digital media assets 710, which can be provided either manually by users, or using a face recognition algorithm. Likewise, the metadata 720 can include the names of objects pictured in the digital media assets 710 or capture locations for the digital media assets 710. The metadata 720 can also include album names, event names, captions, keywords and the like.

In display identifying information step 315, the digital image display device 10 displays identifying information associated with the individuals who shared one or more assets that are currently stored in the non-volatile storage block 22 or the storage media currently connected to the media interface block 32. The identifying information can include, for example, icons that are displayed on the display screen 40. In some embodiments icons can be displayed including pictures of the individuals or graphics associated with the individual (e.g., an avatar). The identifying information can also text strings providing a name, a nickname, a user ID for an account associated with the individual on a social networking website or a digital image sharing website, or some other form of identifier. The display screen 40 can also display one or more image counts for each individual, which can represent the total number of digital media assets received from that individual, or the number of recently received digital media assets from that individual.

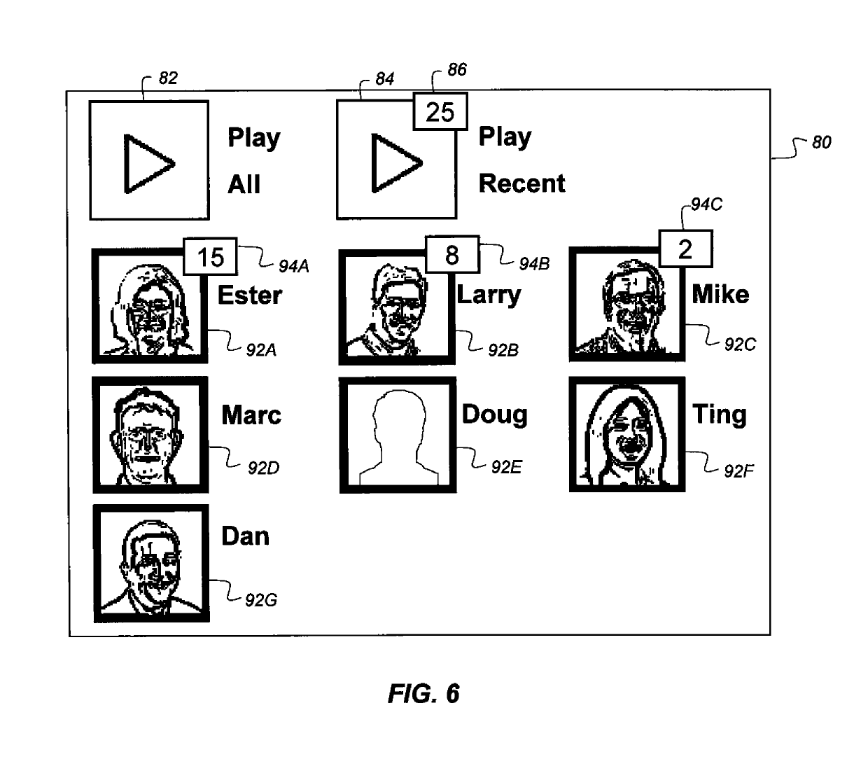

FIG. 6 shows an example of a graphical user interface 80 which can be displayed on the display screen 40. The graphical user interface 80 includes a “Play all” icon 82, which can be selected by the user in order to display all of the digital media assets stored in the digital image display device 10. The graphical user interface 80 also includes a “Play recent” icon 84, which can be selected by the user in order to display only those assets which have recently been received by the digital image display device 10. The time period for determining recently received images can be a factory default value (e.g., digital media assets received during the last 10 days), or can be a time period selected by the user in association with obtain configuration information step 265. The method for determining recently received images can also be specified by a number of most recently received digital media assets to display (e.g., the last 100 digital media assets received), which could be a factory default value or a value selected by the user association with obtain configuration information step 265. The number of recently received digital media assets is displayed in recently received assets box 86.

The example graphical user interface 80 shown in FIG. 6 includes seven icons 92A-92G, which represent the seven different individuals who have been the source of the digital media assets currently stored in the digital image display device 10. An icon can include a small photo of the individual, such as the photo of Ester used for icon 92A. The photos can be uploaded or selected by the user, using the web pages user interface 124, when the user enables the digital image display device 10 to receive digital media assets from a plurality of sources, as described earlier with respect to the enable sources step 300. For example, the photo for an individual who is enabled to provide images from a Facebook account can be derived from their Facebook page profile image. In some embodiments, the central processor 20 in the digital image display device 10 can enable the user to select and crop one of the stored digital still images in order to provide a small photo of an individual who has provided digital media assets. If a small photo of a particular individual is not available, a generic icon can be used, such as icon 92E.

It will be understood that in order to display a larger number of icons (e.g., 30 icons) for a larger number of individuals, a subset (e.g., 9 icons) of the total number of icons can be displayed, along with appropriate navigation icons that enable the user to scroll through the larger number of icons.

The icons 92A-92G can be displayed using an order such that individuals who have most recently shared digital media assets are shown nearer the top of the graphical user interface 80. In some embodiments, the number of digital media assets recently received from each individual can be displayed, as shown in recently received assets boxes 94A, 94B, and 94C, which are associated with the corresponding icons 92A, 92B, and 92C. For example, recently received assets box 94C indicates that two digital media assets have been recently received from Mike.

It will be understood that some embodiments can also include graphical user interface elements that enable the user to select digital media assets that include particular people, albums, stories, events, or capture time periods. This can enable the user to select a subset of the digital media assets provided by a particular individual for display. For example, after the user selects one of the icons 92A-92G, an additional graphical user interface can be invoked to enable the user to select a particular album name, a capture time period, and the like. In such an embodiment, only the digital media assets from the selected individual which are associated with the selected album or time period will then be displayed, unless the user subsequently overrides this selection by selecting a “display all” icon in order to display all images from the selected individual.

In select individual step 320 of FIG. 5, the user employs the user input interfaces block 30 to select one of the individuals, for example by selecting of the icons 92A-92G from the graphical user interface 80 displayed on the display screen 40. For example, if user input interfaces block 30 includes a touch screen disposed in front of the display screen 40, the user may touch one of the icons 92A-92G in order to select a particular individual. The touch screen user interface provides an input to the central processor 20 that the user wants to view only the digital media assets provided by the individual represented by the particular icon selected by the user.

It will be understood that the digital image display device 10 may employ various types of user interfaces that can be used by the user to select an icon associated with a particular individual. For example, in some embodiments arrow navigation keys and a selection key can be used to navigate to and select the icon for a particular individual. In other embodiments, the digital image display device could include a microphone and voice recognition algorithm, and the user could speak the name or nickname of the person associated the icon (e.g., “Mike” or “Doug”) in order to select the desired icon.

In retrieve images step 325, the central processor 20 in the digital image display device 10 retrieves the digital media assets associated with the selected individual. For example, if the “Mike” icon 92C in the example graphical user interface 80 of FIG. 6 is selected in the select individual step 320, the digital media assets subset 730 depicted in FIG. 7B will be retrieved by the central processor 20. Thus, FIG. 7B depicts digital media assets 710 from the collection of digital media assets 700 in FIG. 7A that will be displayed when the “Mike” icon 92C is selected using the graphical user interface 80 of FIG. 6. In this example, the digital media assets subset 730 includes digital media assets received using three different sharing methods (upload, Kodak Gallery and E-mail).

It will be understood that in some operating modes of the digital image display device 10, the digital media assets 710 shown in FIG. 7B can be retrieved one at a time from the non-volatile storage block 22, and stored in the buffer memory block 24. In some operating modes of the digital image display device 10, several digital media assets can be retrieved from the non-volatile storage block 22, and the central processor 20 can form a montage image which includes small versions of the several selected digital media assets. This montage image can be stored in the buffer memory block 24.

As a second example, if the “Larry” icon 92B is selected, the digital media assets subset 740 depicted in FIG. 7C will be retrieved by the central processor 20. Thus, FIG. 7C depicts the digital media assets 710 from the collection of digital media assets 700 in FIG. 7A that will be displayed when the “Larry” icon 92B is selected using the graphical user interface 80 of FIG. 6. In this example, the digital media assets subset 740 includes digital media assets received using a single sharing method (Kodak Gallery).

In display images step 330 (FIG. 5), the digital image display device 10 displays the retrieved digital media assets on the display screen 40. In some operating modes, the digital media assets can be displayed one at a time using a slide show mode. In other operating modes, several digital media assets can be displayed together on the display screen 40 in the form of a montage image. In some embodiments, the particular icon selected by the user (e.g., the “Mike” icon 92C in FIG. 6) can be displayed in a corner of the display screen 40 along with the digital media assets associated with the selected icon. In some embodiments, the digital image display device 10 may prioritize the displayed digital media assets based on how recently they were received. For example, the system may first show all recently received digital media assets that are associated with the individual selected by the user in select individual step 320, and then proceed to display the rest of the digital media assets received from the individual.

It will be understood that the digital media assets and metadata can be provided to the digital image display device 10 using systems other that the one depicted in FIG. 3. For example, a personal computer connected to the Internet can be used to obtain digital media assets and metadata from a variety of individuals that are provided, for example, by E-mail server 140 or content providing systems 150. The digital media assets and metadata can then be stored on a removable storage device, such as a SD memory card or a USB jump drive. The removable storage device can then be removed from the personal computer and connected to the media interface block 32 of the digital image display device 10. The digital media assets and metadata can be transferred, under the control of central processor 20, from the removable storage device to the non-volatile storage block 22.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

A computer program product can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

### PARTS LIST

10 digital image display device
20 central processor
21 real-time clock
22 non-volatile storage block
24 buffer memory block
30 user input interfaces block
31 user buttons
32 media interface block
33 interface connector
34 network interface block
40 display screen
42 display compensation block
44 speaker(s)
46 audio codec block
50 power supply
52 frame surround
54 sliders
80 graphical user interface
82 play all icon
84 play recent icon
86 recently received assets box
92A icon
92B icon
92C icon
92D icon
92E icon
92F icon
92G icon
94A recently received assets box
94B recently received assets box
94C recently received assets box
102 routing server
104 action logging server
106 authentication server
110 content and configuration server
120 web page server
122 administration configuration interface
124 web pages user interface
130 digital image and metadata content storage
140 E-mail server
150 content providing system
152 external content media server
154 external content host
156 external digital image and metadata content
200 obtain list of digital media assets step
205 read next digital media asset step
210 decompress data step
215 resize image for display step
220 compensate image data for display step
225 display image step
230 respond to user interface inputs step
235 wait to display next digital media asset step
250 identify server(s) step
255 obtain security code token step
260 obtain and store new content step
265 obtain configuration information step
300 enable sources step
305 transfer images step
310 store images and metadata step
315 display identifying information step
320 select individual step
325 retrieve images step
330 display images step
700 collection of digital media assets
710 digital media asset
720 metadata
730 digital media assets subset
740 digital media assets subset

1. A digital image display device for displaying a collection of digital media assets, comprising:
a display screen;
a processor;
a network connection for receiving digital media assets provided by a plurality of individuals using one or more sharing methods;
an image memory for storing the received digital media assets together with metadata associated with the received digital media assets, wherein the metadata includes an association of the received digital media assets with the corresponding individuals who provided the received digital media assets;
a user interface for receiving input from a user of the digital image display device; and
a processor-accessible program memory storing executable instructions for causing the processor to execute the steps of:
displaying identifiers on the display screen for a plurality of individuals who have provided digital media assets;
receiving input from a user of the digital image display device via the user interface identifying a particular one of the plurality of individuals;
selecting one or more of the received digital media assets provided by the identified individual, wherein the received digital media assets are selected responsive to the metadata associating the received digital media assets with the corresponding individuals; and
displaying the selected digital media assets on the display screen.

2. The digital image display device of claim 1 wherein the plurality of sharing methods include an E-mail sharing method, a social networking website sharing method, a digital image sharing website sharing method, a web browser upload sharing method or a direct network upload sharing method.

3. The digital image display device of claim 1 wherein the received digital media assets are digital still images or digital video images captured using a digital camera, or are scans of photographic prints or film captured using a digital image scanner.

4. The digital image display device of claim 1 wherein the selected digital media assets include digital media assets provided using at least two different sharing methods.

5. The digital image display device of claim 1 wherein the metadata includes metadata providing an image caption for the received digital media asset, metadata identifying one or more keywords associated with the received digital media asset, metadata identifying persons in the received digital media asset, metadata identifying objects in the received digital media asset, metadata identifying an event associated with received digital media asset, metadata identifying a capture location for the received digital media asset, metadata indicating an image capture date for the received digital media asset, metadata indicating a date that the received digital media asset was provided, or metadata indicating a sharing method by which the received digital media asset was provided.

6. The digital image display device of claim 5 wherein the processor-accessible program memory further stores executable instructions for causing the processor to execute the steps of:
receiving input from the user of the digital image display device via the user interface identifying a search criterion;
selecting a subset of the selected digital media assets that satisfy the search criterion responsive to the received metadata; and
displaying the selected digital media assets on the display screen.

7. The digital image display device of claim 6 wherein the search criterion specifies that the digital media asset is included in a specified album, that the digital media asset is associated with a specified keyword, that the digital media asset includes one or more specified persons or objects, that the digital media asset was captured at a specified capture location, that the digital media asset was captured within a specified date range, that the digital media asset was received within a specified date range, or that the digital media asset was received with a specified sharing method.

8. The digital image display device of claim 1 wherein the network connection is a wireless network connection.

9. The digital image display device of claim 1 wherein the user interface includes a touch screen, a pointing device, one or more buttons, a remote control, a gesture recognition interface or a voice recognition interface.

10. The digital image display device of claim 1 wherein the displayed identifiers include text strings providing identifying information for one or more of the plurality of individuals.

11. The digital image display device of claim 10 wherein the identifying information is a name of the individual, or a user ID for an account associated with the individual on a social networking website or a digital image sharing website.

12. The digital image display device of claim 1 wherein the displayed identifiers include icons corresponding to one or more of the plurality individuals.

13. The digital image display device of claim 12 wherein at least one of the icons includes an image of one of the individuals or an avatar of one of the individuals.

14. The digital image display device of claim 13 wherein the image or the avatar is received from an account on a remote system associated with the individual.

15. The digital image display device of claim 12 wherein the user interface is a touch screen interface, and wherein the user provides input by touching the icon corresponding to the particular one of the plurality of individuals.

16. The digital image display device of claim 1 wherein the selected digital media assets are displayed as a slide show or as one or more montage images.

17. The digital image display device of claim 1 wherein at least some of the digital media assets are stored on a network server until such time that they are needed for display on the digital image display device.
